(19) United States
(12) Patent Application Publication
(10) Pub. No.: US 2010/0333052 A1
(43) Pub. Date: Dec. 30, 2010

(54) Method of manufacturing semiconductor device, semiconductor inspection apparatus, and program

(75) Inventor: Hideaki Tsuchiya, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki-shi (JP)

(21) Appl. No.: 12/588,151

(22) Filed: Oct. 6, 2009

(30) Foreign Application Priority Data
Jun. 26, 2009 (JP) 2009-152951

(51) Int. Cl. G06F 17/50

(52) U.S. Cl. 716/106

(57) ABSTRACT

A reliability reference storage unit stores reference data for dividing semiconductor devices into equal to or more than three reliability ranks on the basis of the magnitude of an overlay error between a first interconnect layer and a second interconnect layer disposed over the first interconnect layer. An error storage unit stores overlay errors measured at multiple points within the surface of a semiconductor wafer. An error calculation unit calculates the overlay errors for a plurality of semiconductor chips on the basis of the coordinates of the plurality of semiconductor chips within the surface of the semiconductor wafer and the overlay errors stored in the error storage unit. A reliability information providing unit provides reliability information indicating reliability ranks to the plurality of semiconductor chips on the basis of the overlay errors for the plurality of semiconductor chips and reference data.

The application is based on Japanese patent application No. 2009-152951, the content of which is incorporated hereinto by reference.

### BACKGROUND

1. Technical Field

The present invention relates to a method of manufacturing a semiconductor device, a semiconductor inspection apparatus, and a program which are capable of sorting semiconductor chips on the basis of reliability.

2. Related Art

The recent miniaturization of semiconductor devices has resulted in a narrower arrangement gap between interconnects having a damascene structure. With the narrower arrangement gap between interconnects, an insulating film between interconnects is likely to undergo time dependent dielectric breakdown (TDDB). For this reason, in the miniaturized semiconductor devices, it is important to predict the TDDB lifetime.

For example, Japanese Unexamined Patent Publication No. 2008-282272 describes a design support apparatus for a semiconductor device which predicts the TDDB lifetime by statistically processing the variation in various pattern shapes. This design support apparatus uses design data, on the basis of which semiconductor devices are manufactured, to predict the TDDB lifetime of the semiconductor devices.

Japanese Unexamined Patent Publication No. 2007-095953 describes a method and an apparatus which specify and sort defective semiconductor devices on the basis of inspection data acquired by inspection during the process of manufacturing semiconductor devices.

Semiconductor chips show variation in manufacturing, and accordingly, semiconductor chips which are manufactured on the basis of the same design data show variation in the TDDB lifetime. Meanwhile, in recent years, the same semiconductor chips have been used for multiple purposes. In this case, the necessary TDDB lifetime of the semiconductor chip differs according to purpose. For this reason, it is necessary to sort semiconductor chips on the basis of the TDDB lifetime.

### SUMMARY

In one embodiment, there is provided a method of manufacturing a semiconductor device. The method includes storing, in a reliability reference storage unit, reference data for dividing semiconductor devices into equal to or more than three reliability ranks on the basis of the magnitude of an overlay error between a first interconnect layer and a second interconnect layer disposed over the first interconnect layer, when the first interconnect layer and the second interconnect layer are formed over a semiconductor wafer from which a plurality of semiconductor chips are cut out, measuring the overlay error at multiple points within the surface of the semiconductor wafer and storing the overlay error in an error storage unit, calculating the overlay errors for the plurality of semiconductor chips on the basis of the coordinates of the plurality of semiconductor chips within the surface of the semiconductor wafer and the overlay error stored in the error storage unit, and providing reliability information indicating the reliability ranks to the plurality of semiconductor chips on the basis of the overlay errors for the plurality of semiconductor chips and reference data stored in the reliability reference storage unit.

The inventors have examined and found that the TDDB lifetime of the semiconductor device correlates with the overlay error between the interconnect layers. For this reason, it is possible to create reference data for dividing semiconductor devices into equal to or more than three reliability ranks on the basis of the magnitude of the overlay error. Therefore, as in the invention, if the overlay error between the interconnect layers is measured and the overlay error is compared with reference data, it is possible to provide reliability information indicating the reliability ranks to the semiconductor chips. As a result, it is possible to sort the semiconductor chips on the basis of the TDDB lifetime.

In another embodiment, there is provided a semiconductor inspection apparatus. The semiconductor inspection apparatus includes a reliability reference storage unit which stores reference data for dividing semiconductor chips into equal to or more than three reliability ranks on the basis of the magnitude of an overlay error between a first interconnect layer and a second interconnect layer disposed over the first interconnect layer, an error storage unit which stores the overlay error measured at multiple points within the surface of a semiconductor wafer from which a plurality of semiconductor chips are cut out, an error calculation unit which calculates the overlay errors for the plurality of semiconductor chips on the basis of the coordinates of the plurality of semiconductor chips within the surface of the semiconductor wafer and the overlay error stored in the error storage unit, and a reliability information providing unit which provides reliability information indicating the reliability ranks to the plurality of semiconductor chips on the basis of the overlay errors for the plurality of semiconductor chips and reference data stored in the reliability reference storage unit.

In yet another embodiment, there is provided a program which causes a computer to function as a semiconductor inspection apparatus. The program causes the computer to execute storing reference data for dividing semiconductor devices into equal to or more than three reliability ranks on the basis of the magnitude of an overlay error between a first interconnect layer and a second interconnect layer disposed over the first interconnect layer, storing the overlay error measured at multiple points within the surface of a semiconductor wafer from which a plurality of semiconductor chips are cut out, calculating the overlay errors for the plurality of semiconductor chips on the basis of the coordinates of the plurality of semiconductor chips within the surface of the semiconductor wafer and the overlay error stored in the error storage unit, and providing reliability information indicating the reliability ranks to the plurality of semiconductor chips on the basis of the overlay errors for the plurality of semiconductor chips and reference data stored in the reliability reference storage unit.

According to the embodiments of the invention, reliability information indicating reliability ranks is provided to semiconductor chips. As a result, it is possible to sort semiconductor chips on the basis of TDDB lifetime.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram showing the configuration and use environment of a semiconductor inspection apparatus according to a first embodiment of the invention;

FIGS. 2A and 2B are diagrams showing the interconnect structure of a semiconductor wafer;

FIG. 3 is a graph showing an example of the relationship between frequency of failure occurrence due to TDDB and time for the overlay error of interconnect layer;

FIG. 4 is a diagram showing an example of reference data which is stored in a reliability reference storage unit;

FIG. 5 is a diagram showing data which is stored in a chip coordinate storage unit in a table format;

FIG. 6 is a diagram showing data which is stored in an error storage unit in a table format;

FIG. 7 is a diagram showing data which is stored in a reliability information storage unit in a table format;

FIG. 8 is a flowchart showing a method of manufacturing a semiconductor device using a semiconductor inspection apparatus shown in FIG. 1;

FIGS. 9A and 9B are diagrams showing reference data which is stored in a reliability reference storage unit according to a second embodiment of the invention; and

FIG. 10 is a diagram showing reference data which is stored in a reliability reference storage unit according to a third embodiment of the invention.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

The embodiments of the invention will be described with reference to the drawings. In the drawings, the same components are represented by the same reference numerals, and descriptions thereof will not be repeated.

### First Embodiment

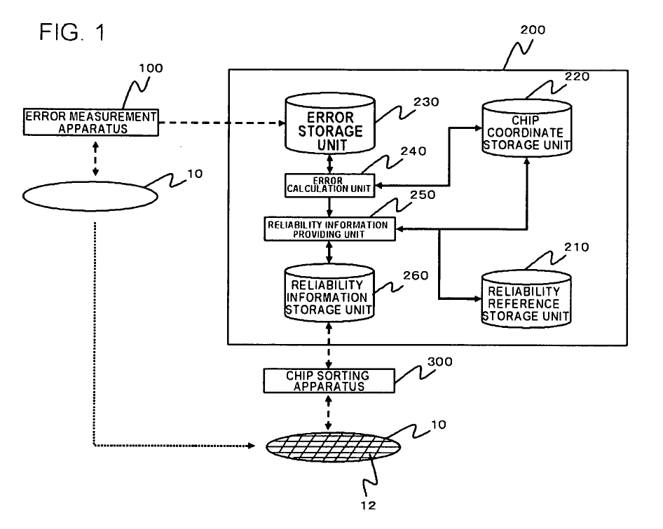

FIG. 1 is a diagram showing the configuration and use environment of a semiconductor inspection apparatus 200 of this embodiment. The semiconductor inspection apparatus 200 includes a reliability reference storage unit 210, an error storage unit 230, an error calculation unit 240, and a reliability information providing unit 250. The reliability reference storage unit 210 stores reference data for dividing semiconductor devices into equal to or more than three reliability ranks on the basis of the magnitude of an overlay error between a first interconnect layer and a second interconnect layer disposed over the first interconnect layer. The error storage unit 230 stores the overlay error measured at multiple points within the surface of a semiconductor wafer 10 from which a plurality of semiconductor chips 12 are cut out. The error calculation unit 240 calculates the overlay errors for the plurality of semiconductor chips 12 on the basis of the coordinates of the plurality of semiconductor chips 12 within the surface of the semiconductor wafer 10 and the overlay error stored in the error storage unit 230. The reliability information providing unit 250 provides reliability information indicating the reliability ranks to the plurality of semiconductor chips 12 on the basis of the overlay errors for the plurality of semiconductor chips 12 and reference data stored in the reliability reference storage unit 210.

The semiconductor inspection apparatus 200 also includes a chip coordinate storage unit 220 and a reliability information storage unit 260. The chip coordinate storage unit 220 stores coordinate information indicating the positions of the plurality of semiconductor chips 12 within the semiconductor wafer 10 in association with chip identification information for identifying the semiconductor chips. The reliability information storage unit 260 stores the reliability information provided by the reliability information providing unit 250 in association with chip identification information of the semiconductor chips.

The error storage unit 230 of the semiconductor inspection apparatus 200 acquires the overlay error of the second interconnect layer with respect to the first interconnect layer from an error measurement apparatus 100. The error measurement apparatus 100 captures the image of the semiconductor wafer 10 from the front surface side. An insulating layer which forms the second interconnect layer has light transmittance, so image data obtained here includes the first interconnect layer as well as the second interconnect layer. For this reason, the error measurement apparatus 100 can calculate the overlay error of the second interconnect layer with respect to the first interconnect layer by processing captured image data.

The reliability information stored in the reliability information storage unit 260 of the semiconductor inspection apparatus 200 is used in a chip sorting apparatus 300. The chip sorting apparatus 300 dices the semiconductor wafer 10 into the semiconductor chips 12, picks up the separated semiconductor chip 12, and accommodates the semiconductor chip 12 in a container (not shown in the drawings). At this time, the chip sorting apparatus 300 reads, on the basis of position information of the next semiconductor chip 12 to be picked up, the reliability information of the semiconductor chip 12 from the reliability information storage unit 260, and sorts the semiconductor chip 12 on the basis of the read reliability information. For this reason, the chip sorting apparatus 300 can sort the semiconductor chips on the basis of reliability. As described below, reliability is based on the expected length of TDDB lifetime.

In FIG. 1, the configuration of portions which are not related to the essence of the invention is not shown. The components of the semiconductor inspection apparatus 200 shown in FIG. 1 are expressed as blocks on the functional basis, not as the configuration on the hardware basis. The components of the semiconductor inspection apparatus 200 may be implemented by arbitrary combinations of hardware and software, mainly including a CPU of an arbitrary computer, a memory, a program loaded to the memory to realize the components of FIG. 1, a storage unit, such as a hard disk or the like, storing the program, and an interface for network connection. Those skilled in the art may readily understand that various modifications may be permitted for methods and apparatuses realizing the configuration. When a program is installed on a computer, a removable medium in which the program is stored may be used, or a program may be downloaded to a computer through a communication network.

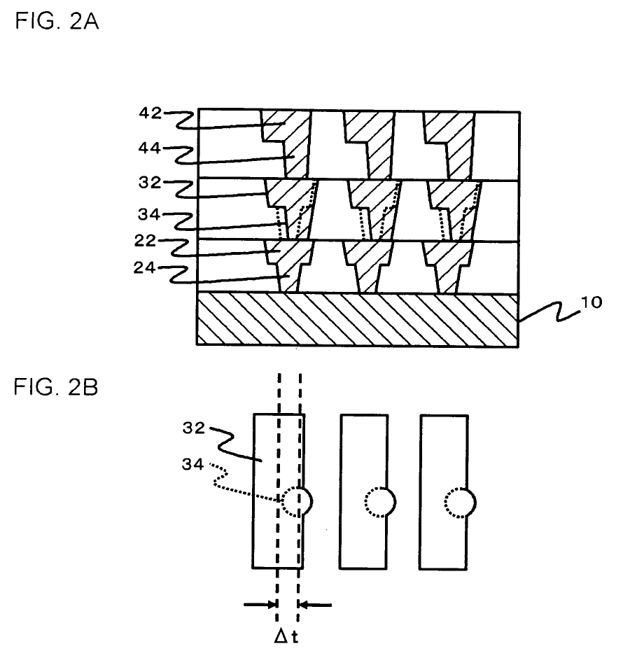

FIGS. 2A and 2B are diagrams showing the interconnect structure of the semiconductor wafer 10. FIG. 2A is a sectional view, and FIG. 2B is a plan view. In the semiconductor wafer 10, a plurality of interconnect layers are laminated. In the example of FIG. 2A, a via layer 24, an interconnect layer 22, a via layer 34, an interconnect layer 32, a via layer 44, and an interconnect layer 42 are laminated in that order. The via layer 24, the interconnect layer 22, the via layer 34, the interconnect layer 32, the via layer 44, and the interconnect layer 42 are formed by, for example, a dual damascene method. The dual damascene method used here is, for example, a via first method.

Each interconnect layer (or via layer) has an overlay error with respect to an underlying via layer (or interconnect layer). Interconnects and vias have a tapered shape in which the upper end is wider. In the example of FIGS. 2A and 2B, the via layer 34 needs to be provided at a position indicated by a dotted line of FIG. 2A, but actually shifted in an arrow direction. In such a case, as shown in FIG. 2B, the interconnect layer 32 has an overlay error Δt with respect to the via layer 34. Similarly, the via layer 44 has an overlay error with respect to the interconnect layer 32. The error measurement apparatus 100 shown in FIG. 1 measures the overlay error of equal to or upper than a second interconnect layer or via layer with respect to an underlying via layer or interconnect layer at multiple points within the surface of the semiconductor wafer 10.

For example, when the position of the via layer in FIG. 2A is shifted (for example, a position indicated by a solid line in the via layer 34) from the original position (for example, a position indicated by a dotted line in the via layer 34), the width of the interconnect layer disposed over the via layer may become wider (for example, a width indicated by a solid line in the interconnect layer 32) than the original width (for example, a width indicated by a dotted line in the interconnect layer 32) due to the shifted width, and thus the interconnect interval of the interconnect layer may become narrow. For this reason, the overlay error between the via layer and the overlying interconnect layer particularly has a large effect on the TDDB lifetime.

The error storage unit 230 of the semiconductor inspection apparatus 200 stores the overlay error measured by the error measurement apparatus 100 for equal to or upper than the second interconnect layer. The error calculation unit 240 calculates the overlay errors for equal to or upper than the second interconnect layer for the plurality of semiconductor chips 12. The reliability information providing unit 250 provides reliability information for equal to or upper than the second interconnect layer, and determines a reliability rank on the basis of combination of reliability information.

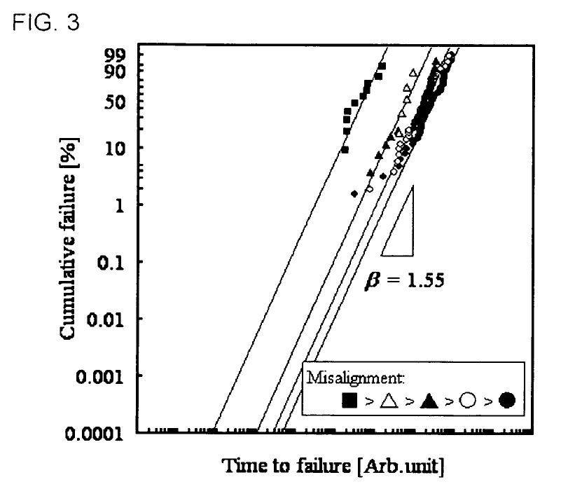

FIG. 3 is a graph showing an example of the relationship between frequency of failure occurrence due to TDDB and time by the overlay error (Misalignment) of the interconnect layers. As time passes, the frequency of failure occurrence due to TDDB increases, but as the overlay error of the interconnect layer increases, the frequency of failure occurrence for the same time increases. That is, if the overlay error is large, the TDDB lifetime is shortened. For this reason, if the correlation between the overlay error and the TDDB lifetime is examined in advance and the examination result is used, it is possible to create reference data for sorting the semiconductor devices into equal to or more than three reliability ranks.

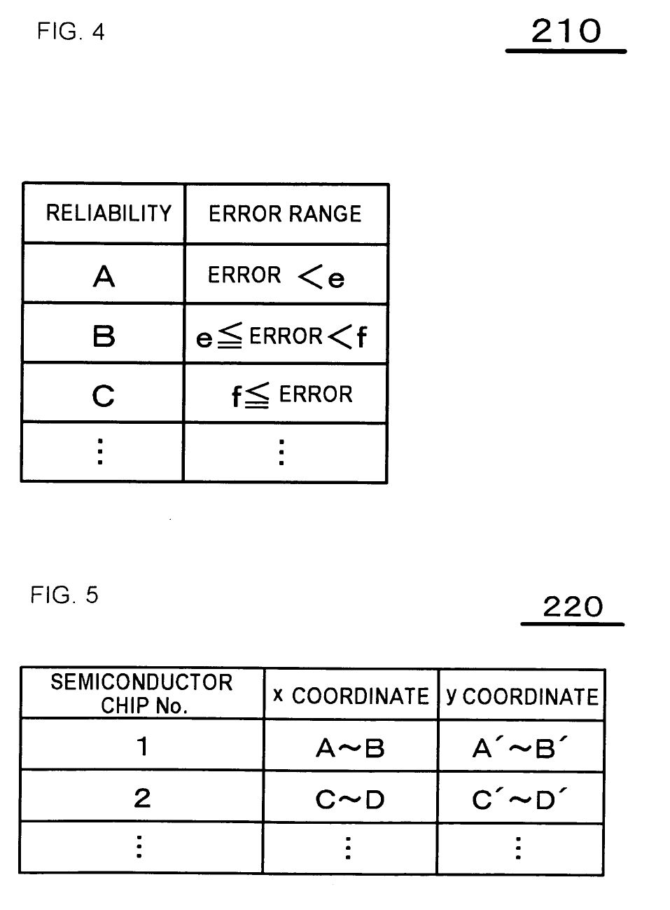

FIG. 4 is a diagram showing an example of reference data which is stored in the reliability reference storage unit 210. In the example of FIG. 4, reference data indicates the magnitude of the overlay error for equal to or more than three reliability ranks. Specifically, reliability data is data in a table format, and reliability information indicating reliability ranks is associated with information indicating the range of the overlay error. According to data in FIG. 4, if the overlay error increases, the reliability rank is lowered. In the example of FIG. 4, the reliability rank A has the highest reliability, and the reliability rank C has the lowest reliability.

FIG. 5 is a diagram showing data which is stored in the chip coordinate storage unit 220 in a table format. The chip coordinate storage unit 220 stores the range of an x coordinate and the range of a y coordinate of the area occupied by each semiconductor chip by chip identification information (semiconductor chip No.) for identifying the semiconductor chips. The origin of the coordinate axes is, for example, the center of the semiconductor wafer, but it is not limited thereto.

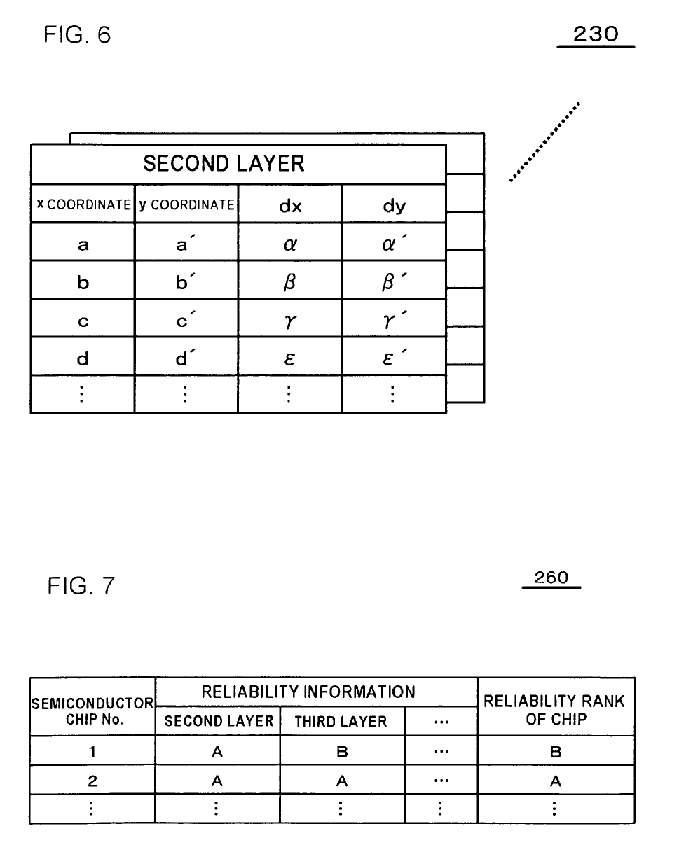

FIG. 6 is a diagram showing data which is stored in the error storage unit 230 in a table format. The error storage unit 230 stores the measurement result of the overlay error of the interconnect layer with respect to the underlying interconnect layer for each interconnect layer above the second interconnect layer of the semiconductor wafer 10. Specifically, information stored in the error storage unit 230 includes the x and y coordinates of the measurement point measured by the error measurement apparatus 100, an error dx in the x-axis direction, and an error dy in the y-axis direction.

FIG. 7 is a diagram showing data which is stored in the reliability information storage unit 260 in a table format. The reliability information storage unit 260 stores reliability information provided on the basis of the chip identification information and the overlay errors of the interconnect layers above the second interconnect layer in association with information indicating the final reliability rank of the semiconductor chip for each semiconductor chip. Information indicating the final reliability rank of the semiconductor chip is set by the reliability information providing unit 250 on the basis of the combination of reliability information provided for the respective interconnect layers above the second interconnect layer. For example, information indicating the reliability ranks of the semiconductor chip is the lowest reliability information from among the reliability information provided by the interconnect layers. Information indicating the reliability ranks of the semiconductor chip may be set in accordance with other references.

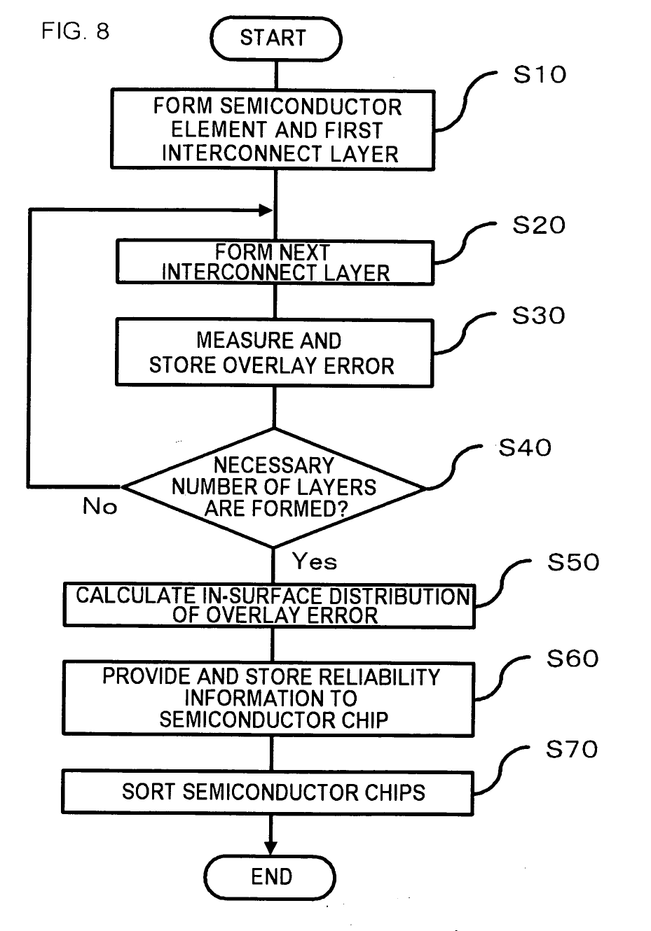

FIG. 8 is a flowchart showing a method of manufacturing a semiconductor device using the semiconductor inspection apparatus 200 shown in FIG. 1. The method of manufacturing a semiconductor device has the following steps. First, when a second interconnect layer and overlying interconnect layers are formed over the semiconductor wafer 10, the overlay error between the interconnect layer and the underlying interconnect layer is measured at multiple points within the surface of the semiconductor wafer 10 and stored in the error storage unit 230 (Steps S30 and S40). Next, the overlay errors are determined for a plurality of semiconductor chips 12 on the basis of the coordinates of the plurality of semiconductor chips 12 within the surface of the semiconductor wafer 10 and the overlay error stored in the error storage unit 230 (Step S50). Next, reliability information indicating reliability ranks is provided to the plurality of semiconductor chips 12 on the basis of the overlay errors for the plurality of semiconductor chips 12 and reference data stored in the reliability reference storage unit 210 (Step S60). Hereinafter, detailed description will be given.

First, an element separation film (not shown in the drawings), semiconductor elements (not shown in the drawings), such as transistors and the like, and a first interconnect layer (for example, the interconnect layer 22 in FIG. 2A) are formed over the semiconductor wafer 10 (Step S10).

Next, the next interconnect layer (for example, the interconnect layer 32 in FIGS. 2A and 2B) is formed (Step S20). Next, the overlay error between the interconnect layer formed in Step S20 and the underlying interconnect layer is measured at equal to or more than four points by using the error measurement apparatus 100 and stored (Step S30). The overlay error measured here includes errors in the x direction and the y direction. The measurement of the overlay error is performed, for example, after a connection hole, an interconnect groove, a plug, and an interconnect are formed in the interconnect layer. Note that necessary information for the measurement is the position of the connection hole and the overlay error with respect to the underlying interconnect layer, so it should suffice that the timing of measurement of the overlay error is after at least the connection hole is formed, insofar as the measurement is possible.

The error measurement apparatus 100 outputs the measured overlay error and the coordinates of the measurement point to the error storage unit 230 of the semiconductor inspection apparatus 200. The error storage unit 230 stores the overlay error and the coordinates of the measurement point output from the error measurement apparatus 100.

Steps S20 and S30 are repeatedly performed until the necessary number of insulating layers are formed (Step S40).

The error calculation unit 240 of the semiconductor inspection apparatus 200 calculates the in-surface distribution of the overlay errors of the semiconductor wafer 10 by Equations (1) and (2) for each interconnect layer (Step S50). Equations which are used by the error calculation unit 240 are not limited to Equations (1) and (2).

dx=−(θₛ+θ_{skew})y+Mₓx+∈ₓ Equation (1)

dy=θₛx+M_{y}y+∈_{y} Equation (2)

For Equations (1) and (2), dx is an overlay error in the x direction, dy is an overlay error in the y direction, θₛ is a rotation error, θ_{skew} is a perpendicularity error, Mₓ is a magnification error in the x direction, M_{y} is a magnification error in the y direction, ∈ₓ is a nonlinear error in the x direction, and ∈_{y} is a nonlinear error in the y direction.

Specifically, the error calculation unit 240 calculates the coefficients in Equations (1) and (2), that is, θₛ, θ_{skewr}, Mₓ, M_{y}, ∈ₓ, and ∈_{y} on the basis of the measurement result stored in the error storage unit 230 for each interconnect layer. The error calculation unit 240 calculates the maximum values of the overlay errors dx and dy in the semiconductor chip 12 on the basis of Equations (1) and (2) and the chip coordinate stored in the chip coordinate storage unit 220 for each interconnect layer. The error calculation unit 240 outputs the calculated overlay errors dx and dy for each interconnect layer to the reliability information providing unit 250 in association with the chip identification information of the semiconductor chip 12. The error calculation unit 240 performs this process for all the semiconductor chips 12.

If the overlay errors dx and dy for each interconnect layer and the chip identification information are received from the error calculation unit 240, the reliability information providing unit 250 applies the received overlay errors dx and dy to data stored in the reliability reference storage unit 210 to provide reliability information for each interconnect layer. The reliability information providing unit 250 stores reliability information for each interconnect layer in the reliability information storage unit 260. Next, the reliability information providing unit 250 determines the reliability rank of the semiconductor chip 12 on the basis of the combination of the reliability information for the interconnect layers, and stores the determination result in the reliability information storage unit 260 (Step S60).

Next, the chip sorting apparatus 300 attaches a dicing tape to the semiconductor wafer 10, and dices the semiconductor wafer 10 into a plurality of semiconductor chips 12. Next, the chip sorting apparatus 300 separately picks up the semiconductor chips 12 from the dicing tape and accommodates them in a container.

At this time, the chip sorting apparatus 300 acquires the chip identification information of the next semiconductor chip 12 to be picked up. Next, the chip sorting apparatus 300 reads a reliability rank corresponding to the acquired chip identification information from the reliability information storage unit 260, and sorts the picked-up semiconductor chip 12 on the basis of the read reliability rank (Step S70).

Here, the semiconductor chips 12 are sorted into equal to or more than three reliability ranks. The semiconductor chips 12 which are sorted into the lowest rank from among equal to or more than the three reliability ranks are defective, and the semiconductor chips 12 which are sorted into other reliability ranks are used for different purposes. Particularly, the semiconductor chips 12 which are sorted into the highest reliability rank are used for the purposes requiring the longest TDDB lifetime.

Next, the operations and effects of this embodiment will be described. As described above, if the overlay error is large, the TDDB lifetime is shortened. Thus, in this embodiment, the correlation between the overlay error and the TDDB lifetime is examined in advance, and reference data for sorting the semiconductor chips 12 into equal to or more than three reliability ranks is created on the basis of the examination result. The error measurement apparatus 100 measures the overlay error of each interconnect layer in the semiconductor wafer 10. The semiconductor inspection apparatus 200 compares the measured overlay error with reference data to determine the reliability ranks for the semiconductor chips 12. Therefore, the semiconductor chips can be sorted on the basis of the TDDB lifetime.

When each interconnect layer is formed, manufacturing costs can be reduced, as compared with a case where a rework is necessary due to some semiconductor chips having a large overlay error. Further, it is unnecessary to remove initial failures by burn-in screening.

In this embodiment, the overlay error of each semiconductor chip 12 is calculated on the basis of Equations (1) and (2). Therefore, the number of measurement points of the overlay error can be made smaller than the number of semiconductor chips 12. Further, although the overlay error distribution is generated in one semiconductor chip 12, the overlay error is calculated on the basis of Equations (1) and (2), so the maximum value of the overlay error in the semiconductor chip 12 can be calculated. As a result, the accuracy of the reliability ranks of the semiconductor chips 12 is improved.

### Second Embodiment

A semiconductor inspection apparatus 200 according to a second embodiment of the invention has the same configuration as the first embodiment, excluding reference data stored in the reliability reference storage unit 210.

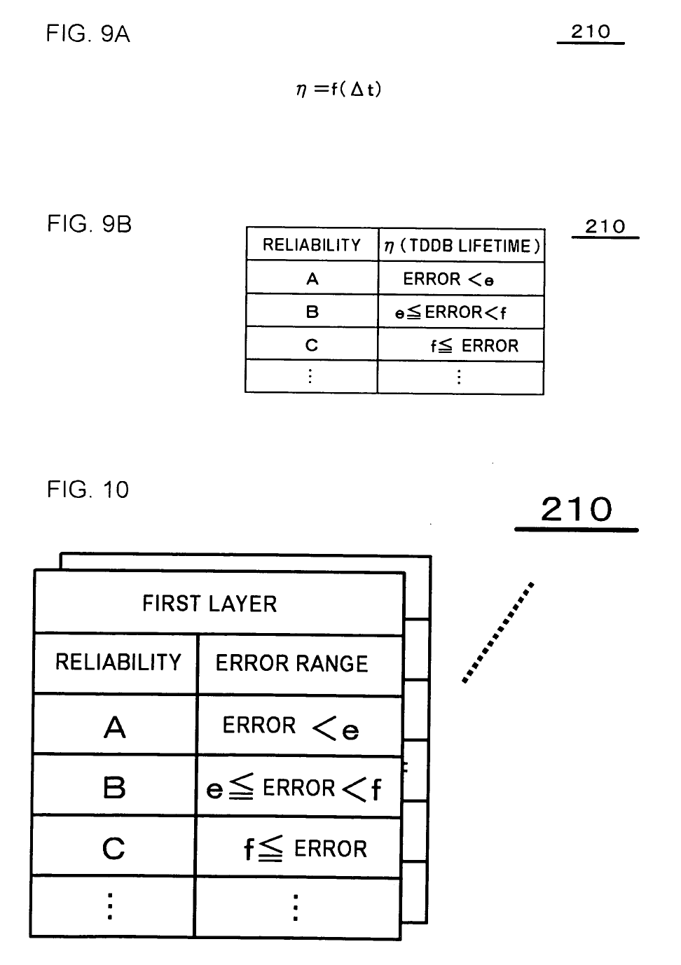

FIGS. 9A and 9B are diagrams showing reference data stored in the reliability reference storage unit 210 according to the second embodiment of the invention. The reliability reference storage unit 210 stores, as reference data, a function indicating the relationship between the overlay error and the TDDB lifetime (FIG. 9A) and data indicating the range of the TDDB lifetime by equal to or more than three reliability ranks (FIG. 9B).

The reliability information providing unit 250 substitutes the maximum value of the overlay error into the function shown in FIG. 9A to calculate the predictive value of the TDDB lifetime in the interconnect layer of the semiconductor chip 12. Next, the reliability information providing unit 250 applies the calculated predictive value of the TDDB lifetime to data shown in FIG. 9B to calculate reliability information in the interconnect layer of the semiconductor chip 12.

The method of manufacturing a semiconductor device in this embodiment is the same as the first embodiment, excluding the method of calculating reliability information for each interconnect layer.

According to this embodiment, the same effects as in the first embodiment can be obtained.

### Third Embodiment

A semiconductor inspection apparatus 200 according to a third embodiment has the same configuration as the first or second embodiment, excluding reference data stored in the reliability reference storage unit 210.

FIG. 10 is a diagram showing reference data stored in the reliability reference storage unit 210 according to the third embodiment of the invention. The reliability reference storage unit 210 stores reference data in association with information indicating an interconnect layer to which relevant reference data is applied. In the example of FIG. 10, the reliability reference storage unit 210 stores a table serving as reference data in association with information indicating an interconnect layer to which relevant reference data is applied. Note that the reliability reference storage unit 210 may store data in the second embodiment serving as reference data in association with information indicating an interconnect layer to which relevant reference data is applied.

The reliability information providing unit 250 changes reference data, which is read from the reliability reference storage unit 210, in accordance with an interconnect layer for which reliability information is to be calculated. The method of manufacturing a semiconductor device in this embodiment is the same as the first or second embodiment excluding the above-described point.

According to this embodiment, the same effects as in the first or second embodiment can be obtained. Further, some semiconductor chips may differ in the interconnect width or minimum interval between the upper interconnect layer and the lower interconnect layer. In such a case, like this embodiment, the reliability information providing unit 250 changes reference data, which is read from the reliability reference storage unit 210, in accordance with an interconnect layer for which reliability information is to be calculated. In this way, the accuracy of reliability information for each interconnect layer provided by the reliability information providing unit 250 is improved.

Although the embodiments of the invention have been described with reference to the drawings, the embodiments are merely for illustrative purposes, and other configuration may be adopted.

It is apparent that the invention is not limited to the above embodiments, but may be modified and changed without departing from the scope and spirit of the invention.

What is claimed is:

1. A method of manufacturing a semiconductor device, comprising:
storing, in a reliability reference storage unit, reference data for dividing semiconductor devices into equal to or more than three reliability ranks on the basis of the magnitude of an overlay error between a first interconnect layer and a second interconnect layer disposed over said first interconnect layer;
when said first interconnect layer and said second interconnect layer are formed over a semiconductor wafer from which a plurality of semiconductor chips are cut out, measuring said overlay error at multiple points within the surface of said semiconductor wafer and storing said overlay error in an error storage unit;
calculating said overlay errors for said plurality of semiconductor chips on the basis of the coordinates of said plurality of semiconductor chips within the surface of said semiconductor wafer and said overlay error stored in said error storage unit; and
providing reliability information indicating said reliability ranks to said plurality of semiconductor chips on the basis of said overlay errors for said plurality of semiconductor chips and said reference data stored in said reliability reference storage unit.

2. The method as set forth in claim 1,
wherein said reference data indicates the magnitude of said overlay error by equal to or more than said three reliability ranks.

3. The method as set forth in claim 1,
wherein said reference data includes
a function indicating the relationship between said overlay error and time dependent dielectric breakdown (TDDB) lifetime, and
data indicating the range of said TDDB lifetime by equal to or more than said three reliability ranks.

4. The method as set forth in claim 1, further comprising:
after the step of storing said overlay error in said error storage unit, separating said semiconductor wafer into said plurality of semiconductor chips; and
after the step of providing said reliability information and the step of separating said semiconductor wafer into said plurality of semiconductor chips, classifying said plurality of semiconductor chips by said reliability ranks.

5. The method as set forth in claim 1,
wherein said semiconductor wafer has a multilayer interconnect layer of equal to or more than three layers including said first interconnect layer and said second interconnect layer,
in the step of measuring said overlay error and storing said overlay error in said error storage unit, for equal to or upper than said second interconnect layer, the overlay error of the relevant interconnect layer with respect to said interconnect layer below the relevant interconnect layer is measured at multiple points within the surface of said semiconductor wafer and stored in said error storage unit,
in the step of calculating said overlay errors for said plurality of semiconductor chips, said overlay error is calculated for equal to or upper than said second interconnect layer by said plurality of semiconductor chips, and
in the step of providing said reliability information to said plurality of semiconductor chips, said reliability information is provided to equal to or upper than said second interconnect layer, and said reliability ranks are determined on the basis of the combination of said reliability information.

6. The method as set forth in claim 5,
wherein said reliability reference storage unit stores said reference data in association with said interconnect layers to which the relevant reference data is applied.

7. The method as set forth in claim 1,
wherein, in the step of storing said overlay error in said error storage unit, said overlay error is measured in the x and y directions for equal to or more than four points and stored in said error storage unit, and
in the step of calculating said overlay errors for said plurality of semiconductor chips, said overlay errors stored in said error storage unit are substituted into Equations (1) and (2) to calculate constants and coefficients of Equations (1) and (2), and then said overlay errors are calculated for said plurality of semiconductor chips.
dx=−(θₛ+θ_{skew})y+Mₓx+∈ₓ Equation (1)
dy=θₛx+M_{y}y+∈_{y} Equation (2)
for Equations (1) and (2), dx is an overlay error in the x direction, dy is an overlay error in the y direction, θₛ is a rotation error, θ_{skew} is a perpendicularity error, Mₓ is a magnification error in the x direction, M_{y} is a magnification error in the y direction, ∈ₓ is a nonlinear error in the x direction, and ∈_{y} is a nonlinear error in the y direction.

8. The method as set forth in claim 2,
wherein said reference data is set on the basis of data indicating the correlation between said overlay error and TDDB lifetime.

9. A semiconductor inspection apparatus comprising:
a reliability reference storage unit which stores reference data for dividing semiconductor devices into equal to or more than three reliability ranks on the basis of the magnitude of an overlay error between a first interconnect layer and a second interconnect layer disposed over said first interconnect layer;
an error storage unit which stores said overlay error measured at multiple points within the surface of a semiconductor wafer from which a plurality of semiconductor chips are cut out;
an error calculation unit which calculates said overlay errors for said plurality of semiconductor chips on the basis of the coordinates of said plurality of semiconductor chips within the surface of said semiconductor wafer and said overlay error stored in said error storage unit; and
a reliability information providing unit which provides reliability information indicating said reliability ranks to said plurality of semiconductor chips on the basis of said overlay errors for said plurality of semiconductor chips and said reference data stored in said reliability reference storage unit.

10. The semiconductor inspection apparatus as set forth in claim 9,
wherein said reference data indicates the magnitude of said overlay error by equal to or more than said three reliability ranks.

11. The semiconductor inspection apparatus as set forth in claim 9,
wherein said reference data includes
a function indicating the relationship between said overlay error and TDDB lifetime, and
data indicating the range of said TDDB lifetime by equal to or more than said three reliability ranks.

12. The semiconductor inspection apparatus as set forth in claim 9,
wherein said semiconductor wafer has a multilayer interconnect layer of equal to or more than three layers including said first interconnect layer and said second interconnect layer,
said error storage unit stores, for equal to or upper than said second interconnect layer, the overlay error of a relevant interconnect layer with respect to an interconnect layer below the relevant interconnect layer, which is an error measured at multiple points within the surface of said semiconductor wafer,
said error calculation unit calculates said overlay error for equal to or upper than said second interconnect layer by said plurality of semiconductor chips, and
said reliability information providing unit provides said reliability information to equal to or upper than said second interconnect layer, and determines said reliability ranks on the basis of the combination of said reliability information.

13. The semiconductor inspection apparatus as set forth in claim 12,
wherein said reliability reference storage unit stores said reference data in association with said interconnect layers to which the relevant reference data is applied.

14. A program which causes a computer to function as a semiconductor inspection apparatus, the program causing the computer to execute:
storing reference data for dividing semiconductor devices into equal to or more than three reliability ranks on the basis of the magnitude of an overlay error between a first interconnect layer and a second interconnect layer disposed over said first interconnect layer;
storing said overlay error measured at multiple points within the surface of a semiconductor wafer from which a plurality of semiconductor chips are cut out;
calculating said overlay errors for said plurality of semiconductor chips on the basis of the coordinates of said plurality of semiconductor chips within the surface of said semiconductor wafer and said overlay error stored in said error storage unit; and
providing reliability information indicating said reliability ranks to said plurality of semiconductor chips on the basis of said overlay errors for said plurality of semiconductor chips and reference data stored in said reliability reference storage unit.

15. The program as set forth in claim 14,
wherein said reference data indicates the magnitude of said overlay error by equal to or more than said three reliability ranks.

16. The program as set forth in claim 14,
wherein said reference data includes
a function indicating the relationship between said overlay error and TDDB lifetime, and
data indicating the range of said TDDB lifetime by equal to or more than said three reliability ranks.

17. The program as set forth in claim 14,
wherein said semiconductor wafer has a multilayer interconnect layer of equal to or more than three layers including said first interconnect layer and said second interconnect layer,
the function of storing said overlay error is a function of, for equal to or upper than said second interconnect layer, storing the overlay error of a relevant interconnect layer with respect to an interconnect layer below the relevant interconnect layer, which is an error measured at multiple points within the surface of said semiconductor wafer,
the function of calculating said overlay errors is a function of calculating said overlay error for equal to or upper than said second interconnect layer by said plurality of semiconductor chips, and
the function of providing said reliability information is a function of providing said reliability information to equal to or upper than said second interconnect layer and determining said reliability ranks on the basis of the combination of said reliability information.

18. The program as set forth in claim 17,
wherein, in the function of storing said reference data, said reference data is stored in association with said interconnect layers to which the relevant reference data is applied.
